(19) United States
(12) Patent Application Publication
(10) Pub. No.: US 2022/0315113 A1
(43) Pub. Date: Oct. 6, 2022

(54) VEHICLE BODY FRONT PART STRUCTURE

(71) Applicant: HONDA MOTOR CO., LTD., Tokyo (JP)

(72) Inventor: Yamato SASANO, Tokyo (JP)

(21) Appl. No.: 17/678,013

(22) Filed: Feb. 23, 2022

(30) Foreign Application Priority Data
Mar. 31, 2021 (CN) 202110353362.9

(51) Int. Cl. B62D 21/15; B62D 25/08; B60R 19/34

(52) U.S. Cl. CPC B62D 21/155; B62D 25/085; B60R 19/34; B60R 2019/1806

(57) ABSTRACT

Provided is a vehicle body front part structure having an increased degree of freedom in design while maintaining transmission performance of collision load. A vehicle body front part structure includes a front side frame, a bumper beam bracket provided at a front end in the front side frame, a subframe provided below the front side frame, and a subframe support provided in a standing manner below a position behind the front end in the front side frame, the subframe support being connected to the subframe, the subframe support includes a pair of left and right side walls and on opposite sides in a vehicle width direction in the subframe support, and each of the pair of left and right side walls and extends forward and is connected to a lower end in the bumper beam bracket.

This application is based on and claims the benefit of priority from Chinese Patent Application CN202110353362.9, filed on 31 Mar. 2021, the content of which is incorporated herein by reference.

### BACKGROUND OF THE INVENTION

### Field of the Invention

The present invention relates to a vehicle body front part structure.

### Related Art

Heretofore, there has been a vehicle body front part structure which stably absorbs impact energy. For example, a vehicle body front part structure described in Patent Document 1 includes a front side frame, a bumper beam bracket provided at a front end in the front side frame, a subframe provided below the front side frame, and a subframe support provided in a standing manner downward from a position of the front end in the front side frame, the subframe support being connected to the subframe. In this vehicle body front part structure, load applied to the subframe support is transmitted through a support inclined surface in the subframe support to the front side frame, and a fragile part in the front side frame is bent, to stably absorb impact energy.

Patent Document 1: Japanese Unexamined Patent Application, Publication No. 2016-150685

### SUMMARY OF THE INVENTION

In a vehicle body front part structure described in Patent Document 1, however, a subframe support has a support inclined surface inclined downward and forward, and hence the subframe support needs to be provided at a position of a front end in a front side frame. Therefore, a degree of freedom in designing arrangement, shape and the like of the front side frame and a subframe is low.

An object of the present invention, which has been made in view of the above problem, is to provide a vehicle body front part structure having an increased degree of freedom in design while maintaining transmission performance of collision load.

(1) According to the present invention, provided is a vehicle body front part structure (e.g., an after-mentioned vehicle body front part structure 1 or 2) including a front side frame (e.g., an after-mentioned front side frame 11), a bumper beam bracket (e.g., an after-mentioned bumper beam bracket 12) provided at a front end in the front side frame, a subframe (e.g., an after-mentioned subframe 14) provided below the front side frame, and a subframe support (e.g., an after-mentioned subframe support 15 or 25) provided in a standing manner below a position behind the front end in the front side frame, the subframe support being connected to the subframe, wherein the subframe support includes a pair of left and right side walls (e.g., an after-mentioned pair of left and right side walls 16 and 17) on opposite sides in a vehicle width direction in the subframe support, and each of the pair of left and right side walls extends forward and is connected to a lower end in the bumper beam bracket.

(2) In the vehicle body front part structure according to (1), the pair of left and right side walls may include flange portions (e.g., after-mentioned flange portions 16a and 17a) each bending in the vehicle width direction.

(3) In the vehicle body front part structure according to (1) or (2), each of the pair of left and right side walls may have a shape gradually expanding downward from front toward rear.

(4) In the vehicle body front part structure according to any one of (1) to (3), the subframe support may include a front wall (e.g., an after-mentioned front wall 18) in front in the subframe support, and in the front wall, an upper part in the front wall may be connected directly to a lower part in the front side frame.

(5) In the vehicle body front part structure according to any one of (1) to (4), the subframe support may include a front wall (e.g., the after-mentioned front wall 18) in front in the subframe support, and the pair of left and right side walls and the front wall may include a plurality of welding flanges (e.g., a plurality of after-mentioned welding flanges 161, 162, 163, 181, and 182) each extending in a front-rear direction, an up-down direction or a left-right direction, and may be welded to one another with the plurality of welding flanges.

(6) In the vehicle body front part structure according to (5), among the plurality of welding flanges, the welding flange (e.g., an after-mentioned welding flange 161 or 181) extending in the left-right direction may extend outward in the vehicle width direction.

(7) In the vehicle body front part structure according to any one of (1) to (6), the subframe support may include a front wall (e.g., an after-mentioned front wall 28) in front in the subframe support, the front wall may be provided inclining such that an upper part is located more forward than a lower part, and the upper part in the front wall may be connected to a lower part in the front side frame.

(8) In the vehicle body front part structure according to (7), in the front wall, inclination angles are different from each other in the upper part and the lower part in the front wall, and the inclination angle of the lower part in the front wall may be about the same as an inclination angle made by a front side in the pair of left and right side walls that inclines forward from bottom toward top.

(9) In the vehicle body front part structure according to any one of (1) to (8), at least one of the pair of left and right side walls may include a hole (e.g., an after-mentioned hole 171) in an upper rear portion in the side wall, and the hole may include a peripheral edge flange (e.g., an after-mentioned peripheral edge flange 171a) extending and bending in the vehicle width direction, in an entire peripheral edge of the hole.

(10) In the vehicle body front part structure according to (9), the peripheral edge flange may extend in a curve in the vehicle width direction.

According to the present invention, there can be provided a vehicle body front part structure having an increased degree of freedom in design while maintaining transmission performance of collision load.

### BRIEF DESCRIPTION OF THE DRAWINGS

FIG. 1 is a perspective view showing a right side part in a vehicle body front part structure according to a first embodiment of the present invention;

FIG. 2 is a perspective view showing a periphery of a right side subframe support;

FIG. 3 is a perspective view showing the periphery of the right side subframe support;

FIG. 4 is a perspective view showing the periphery of the right side subframe support;

FIG. 5 is a perspective view showing the periphery of the right side subframe support;

FIG. 6 is an enlarged perspective view showing a flange portion in the right side subframe support;

FIG. 7 is a perspective view showing a right side part in a vehicle body front part structure according to a second embodiment of the present invention;

FIG. 8 is a perspective view showing a periphery of a right side subframe support;

FIG. 9 is a side view showing the periphery of the right side subframe support;

FIG. 10 is a perspective view showing a left side subframe support; and

FIG. 11 is a side view showing the left side subframe support, and shows load applied to the subframe support at time of front collision of a vehicle body.

### DETAILED DESCRIPTION OF THE INVENTION

Hereinafter, description will be made in detail as to embodiments according to the present invention with reference to the drawings. In the respective drawings, arrow Fr indicates a vehicle body front, arrow U indicates a vehicle body upside, and arrow OB indicates an inner side in a vehicle width direction. Note that in description of a second embodiment, configuration, operation and effect common to those of a first embodiment are not described as required, for example, by denoting with the same reference numerals. Also, in the respective drawings, components are not shown in the drawings as required for convenience of explanation.

### First Embodiment

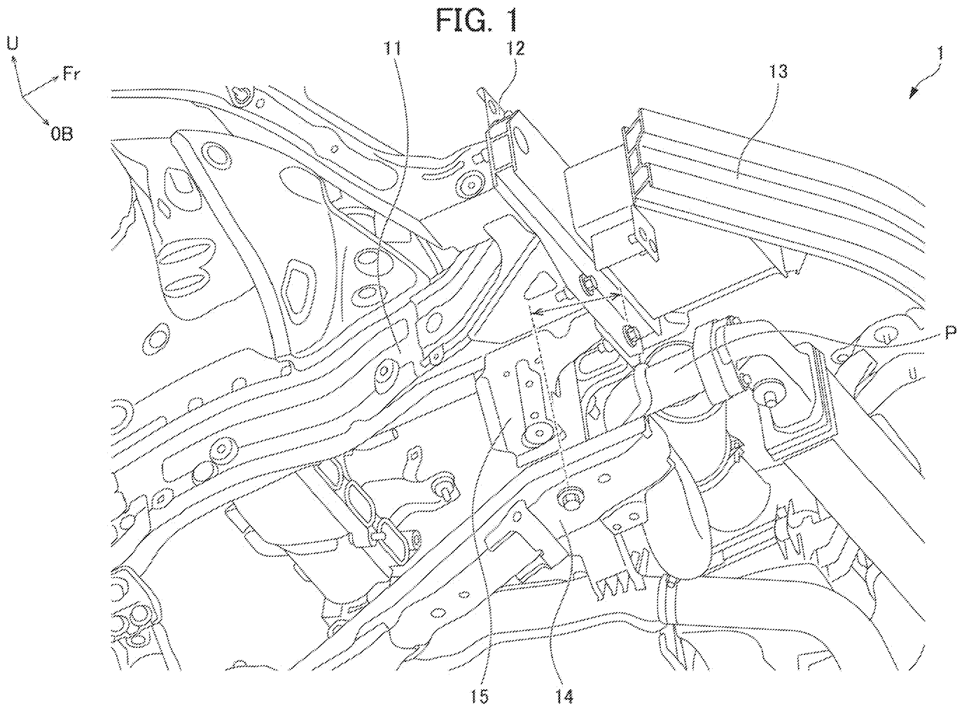

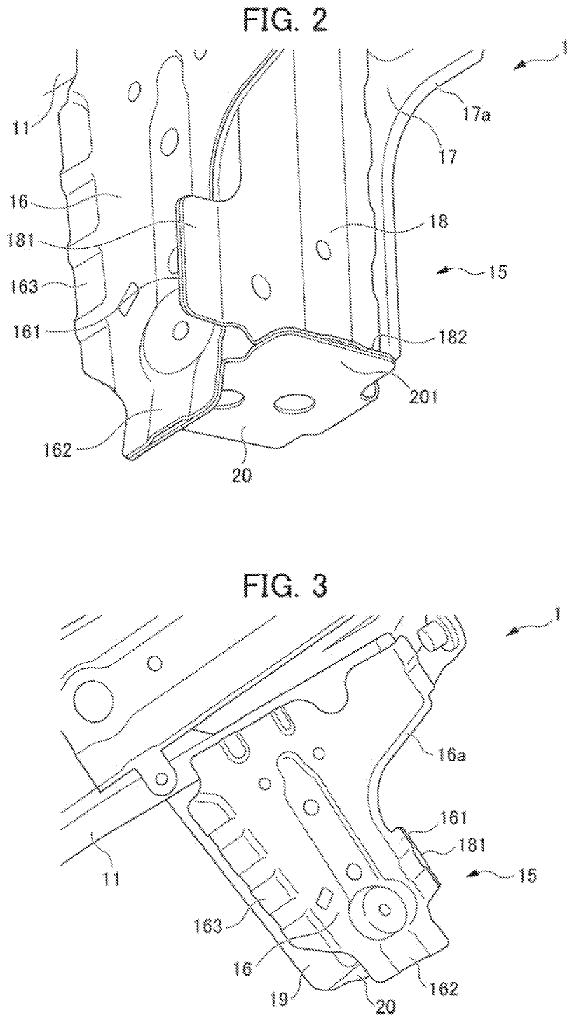

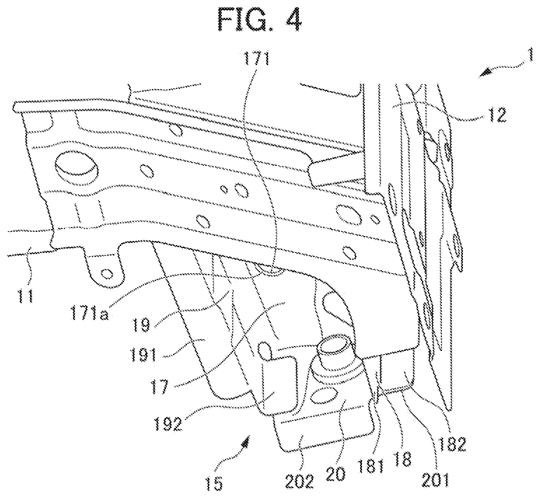

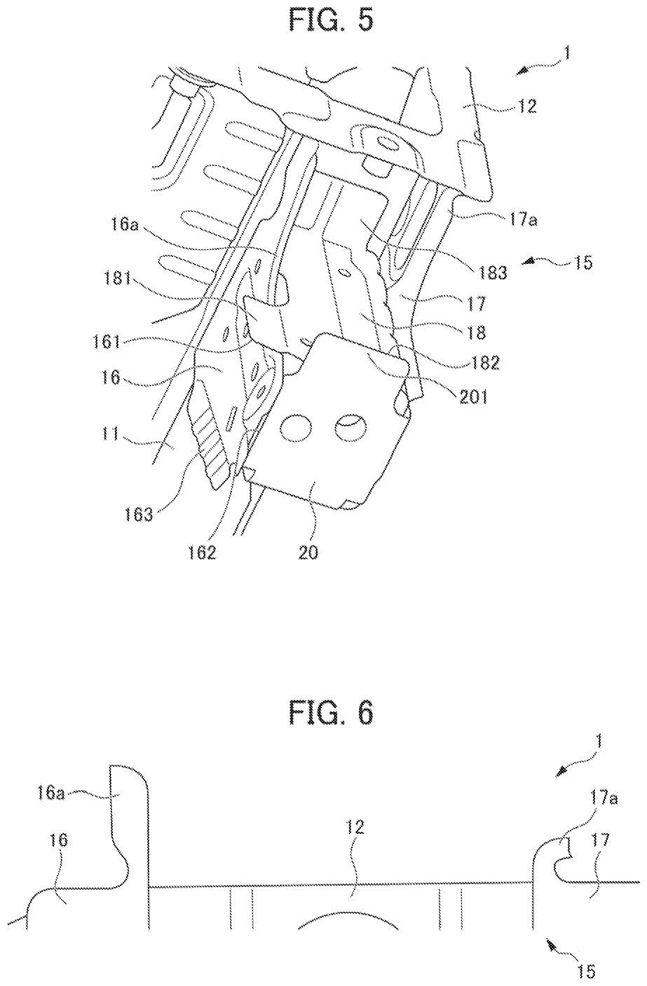

First, description is made as to a configuration of a vehicle body front part structure 1 according to the first embodiment of the present invention with reference to FIGS. 1 to 6. FIG. 1 is a perspective view showing a right side part in the vehicle body front part structure 1. Each of FIGS. 2 to 5 is a perspective view showing a periphery of a right side subframe support 15. FIG. 6 is an enlarged perspective view showing flange portions 16a and 17a in the right side subframe support 15.

The vehicle body front part structure 1 shown in FIGS. 1 to 6 is a structure around an engine room. The vehicle body front part structure 1 absorbs impact energy at time of collision of a vehicle body, to reduce damage in the engine room. Specifically, the vehicle body front part structure 1 includes a pair of left and right front side frames 11, a pair of left and right bumper beam brackets 12, a bumper beam 13, a pair of left and right subframes 14, a pair of left and right subframe supports 15 and the like.

The pair of left and right front side frames 11 are respectively provided on left and right in a vehicle width direction to extend in a front-rear direction in the vehicle body and have a mutually mirror-symmetrical shape. The pair of left and right front side frames 11 are connected to left and right rear parts of the bumper beam 13 via the bumper beam brackets 12 provided at front ends in the front side frames 11, respectively.

As shown by arrows in FIG. 1, each of the pair of left and right front side frames 11 is connected to a position behind a front end in the subframe 14 via the subframe support 15 provided in a standing manner below a position behind the front end in the front side frame 11. This is noticeably different from a vehicle body front part structure in Patent Document 1 described above in which a subframe support has a support inclined surface inclined downward and forward and the subframe support needs to be provided at a position of a front end in a front side frame.

The pair of left and right bumper beam brackets 12 are members that fix the bumper beam 13 to the front ends of the pair of left and right front side frames 11, respectively, and have a mutually mirror-symmetrical shape. Each of the pair of left and right bumper beam brackets 12 is fixed to the front end of the front side frame 11 by welding and fixed to each of the left and right rear parts of the bumper beam 13 with bolts.

The bumper beam 13 is provided in front in the vehicle body front part structure 1 to extend in the vehicle width direction. The bumper beam 13 is fixed to the bumper beam bracket 12 provided at the front end of each of the pair of left and right front side frames 11 with bolts, and thus connected to each of the pair of left and right front side frames 11.

The pair of left and right subframes 14 are provided on the left and right in the vehicle width direction and below the front side frames 11 to extend in the front-rear direction of the vehicle body, respectively, and have a mutually mirror-symmetrical shape. Each of the pair of left and right subframes 14 is connected to the front side frame 11 via the subframe support 15 provided in a standing manner below the position behind the front end in the front side frame 11.

The pair of left and right subframe supports 15 are members that connect the subframes 14 to the front side frames 11 and the bumper beam brackets 12, respectively, and have a mutually mirror-symmetrical shape. Each of the pair of left and right subframe supports 15 is fixed to the position behind the front end in the front side frame 11 by welding and fixed to a lower rear end in the bumper beam bracket 12 by welding. Also, each of the pair of left and right subframe supports 15 is fixed to the position behind the front end in the subframe 14 with bolts.

Next, description will be made in detail as to the pair of left and right subframe supports 15 included in the vehicle body front part structure 1 according to the present embodiment.

As shown in FIGS. 1 to 5, each of the pair of left and right subframe supports 15 is constituted of a box-shaped structure. Specifically, each of the pair of left and right subframe supports 15 includes a pair of left and right side walls 16 and 17, a front wall 18, a rear wall 19, and a bottom surface 20. The pair of left and right side walls 16 and 17, the front wall 18, the rear wall 19, the bottom surface 20 and the front side frame 11 form the box-shaped structure.

Each of the pair of left and right side walls 16 and 17 has a shape gradually expanding downward from front toward rear. The pair of left and right side walls 16 and 17 are provided on opposite sides in the vehicle width direction in the subframe support 15, respectively, and the side walls 16 and 17 have upper ends fixed to the front side frame 11 by welding and have forward extended parts fixed to lower ends in the bumper beam bracket 12 by welding.

Also, as shown in FIG. 6, the pair of left and right side walls 16 and 17 include the flange portions 16a and 17a bending in a direction to separate from each other in the vehicle width direction, in end portions of the forward extended parts, respectively. Each of the flange portions 16a and 17a is provided to extend in a curve in the vehicle width direction and formed to turn to outside each of the pair of left and right side walls 16 and 17.

The side wall 16 on an outer side in the vehicle width direction includes a plurality of welding flanges 161, 162, and 163. The welding flange 161 is a part bending and extending outward in the vehicle width direction at a front end in the side wall 16 and fixed to a welding flange 181 in the front wall 18. The welding flange 162 is a part extending downward from a lower end in the side wall 16 and fixed to a welding flange 202 of the bottom surface 20 by welding. The welding flange 163 is a part extending rearward from a rear end in the side wall 16 and fixed to a welding flange 191 of the rear wall 19 by welding.

The side wall. 17 on an inner side in the vehicle width direction is formed integrally with the rear wall 19 and the bottom surface 20 by bending one metal plate. The side wall 17 includes a hole 171 as a working hole for performing spot welding, in an upper rear portion in the side wall 17. The hole 171 has a substantially perfect circle shape and includes a peripheral edge flange 171a bent outward in the vehicle width direction, in an entire peripheral edge of the hole 171.

The peripheral edge flange 171a is provided to extend in a curve in the vehicle width direction and formed to turn to outside the side wall 17 on the inner side in the vehicle width direction. Therefore, at an angle formed by the peripheral edge of the hole 171 and the peripheral edge flange 171a, a rounded R-shape is formed.

The front wall 18 is provided in front in the subframe support 15, and the front wall 18 has an upper end fixed directly to a lower part in the front side frame 11 by welding. The front wall 18 includes a plurality of welding flanges 181, 182, and 183. The welding flange 181 is a part extending from a side end of the front wall 18 on the outer side in the vehicle width direction to outside in the vehicle width direction and fixed to the welding flange 161 of the side wall 16 on the outer side in the vehicle width direction by welding. The welding flange 182 is a part bending and extending forward at a lower end in the front wall 18 and fixed to a welding flange 201 of the bottom surface 20 by welding. The welding flange 163 is a part bending and extending forward at the upper end in the front wall 18 and fixed to the lower part in the front side frame 11 by welding.

The rear wall 19 is formed integrally with the side wall 17 and the bottom surface 20 on the inner side in the vehicle width direction, by bending one metal plate as described above. The rear wall 19 includes a plurality of welding flanges 191 and 192. The welding flange 191 is a part bending and extending rearward at a side end of the rear wall 19 on the outer side in the vehicle width direction and fixed to the welding flange 163 of the side wall 16 on the outer side in the vehicle width direction by welding. The welding flange 192 is a part bending and extending forward at a lower end in the rear wall 19 and fixed to an upper surface rear end of the bottom surface 20 by welding.

The bottom surface 20 is formed integrally with the side wall 17 and the rear wall 19 on the inner side in the vehicle width direction, by bending one metal plate as described above. The bottom surface 20 includes a plurality of welding flanges 201 and 202. The welding flange 201 is a part extending forward from a front end in the bottom surface 20 and fixed to the welding flange 182 of the front wall 18 by welding. The welding flange 202 is a part bending and extending downward at a side end of the bottom surface 20 on the outer side in the vehicle width direction and fixed to the welding flange 162 of the side wall 16 on the outer side in the vehicle width direction by welding.

Next, description will be made in detail as to the operation and effect of the vehicle body front part structure 1 according to the present embodiment.

According to the vehicle body front part structure 1 of the present embodiment, the subframe support 15 is provided at the position behind the front end in the front side frame 11, so that a degree of freedom in designing arrangement, shape and the like of the front side frame 11 and the subframe 14 increases. A larger space can be acquired in front of the subframe support 15, as compared with a case where the subframe support is conventionally provided at the front end in the front side frame. Therefore, this space can be effectively used, for example, by disposing a pipe P for an intercooler.

Also, according to the vehicle body front part structure 1 of the present embodiment, when the subframe 14 receives impact load, vibration load received by the subframe 14 is transmitted from the subframe 14 to the front side frame 11 through the subframe support 15. Simultaneously, the load is transmitted from the subframe 14 to the bumper beam 13 through the subframe support 15 and the bumper beam bracket 12. Therefore, the vehicle body front part structure 1 according to the present embodiment can have an increased degree of freedom in design while maintaining a transmission performance of collision load.

Also, according to the vehicle body front part structure 1 of the present embodiment, parts extending below the bumper beam bracket 12 can be decreased, which can reduce cost. Furthermore, each of the pair of left and right side walls 16 and 17 extends forward and is connected to the lower end in the bumper beam bracket 12, so that vibration in an up-down direction from a road surface can be transmitted directly to the bumper beam bracket 12 from the subframe 14. Specifically, the vibration in the up-down direction from the road surface can be efficiently transmitted to the bumper beam 13 capable of absorbing vibration, and vibration absorption performance can improve. In particular, the bumper beam 13 connects the left and right subframes 14, and hence vibration of one of the subframes 14 can be transmitted to the other subframe 14, so that the vibration absorption performance can improve.

Also, according to the vehicle body front part structure 1 of the present embodiment, the pair of left and right side walls 16 and 17 include the flange portions 16a and 17a bending in the vehicle width direction, respectively, so that the pair of left and right side walls 16 and 17 can have an improved rigidity. Consequently, in a case of collision below, that is, in a case where impact load is applied below the front side frame 11, the transmission performance of the load to the front side frame 11 can improve.

Further, according to the vehicle body front part structure 1 of the present embodiment, each of the pair of left and right side walls 16 and 17 has the shape gradually expanding downward from front toward rear, and hence, in the case of the collision below, that is, even in the case where the impact load is applied below the front side frame 11, a part connected to the bumper beam bracket 12 in the pair of left and right side walls 16 and 17 and a part extending downward in the pair of left and right side walls 16 and 17 can be inhibited from being fractured in a direction to open to outside. Therefore, the box-shaped subframe support 15 can be more securely maintained, and the transmission performance of the collision load can further improve.

Also, according to the vehicle body front part structure 1 of the present embodiment, when the subframe support 15 is provided in a standing manner below the position behind the front end in the front side frame 11, an upper part of the front wall 18 is connected directly to the front side frame 11, so that the subframe support 15 can be more stably fixed. Therefore, the transmission performance of the collision load or the vibration load can further improve.

Further, according to the vehicle body front part structure 1 of the present embodiment, the pair of left and right side walls 16 and 17 and the front wall 18 are welded to one another with the plurality of welding flanges 161, 162, 163, 181, and 182 extending in the respective directions of the front-rear direction, the up-down direction and the left-right direction, so that the subframe support 15 has load-bearing performance improved in all of the respective directions of the front-rear direction, the up-down direction and the left-right direction.

Also, according to the vehicle body front part structure 1 of the present embodiment, the welding flanges 161 and 181 extending in the left-right direction extend toward the outside in the vehicle width direction, and do not project more inward than the subframe support 15 in the vehicle width direction. Therefore, freedom in layout on an engine room side in a vehicle body front part is not limited.

Further, according to the vehicle body front part structure 1 of the present embodiment, in a case where the hole 171 is provided as the working hole for performing spot welding in the upper rear portion in the side wall 17, the peripheral edge flange 171a bending in the vehicle width direction is provided in the whole peripheral edge of the hole 171, so that fracture starting from the hole 171 can be suppressed. Consequently, damage on the subframe support 15 can be further suppressed, and load can be more efficiently absorbed.

Also, according to the vehicle body front part structure 1 of the present embodiment, the peripheral edge flange 171a is provided to extend in the curve in the vehicle width direction, and hence any stress is not concentrated on a part of the peripheral edge flange 171a. Consequently, the damage on the subframe support 15 can be suppressed, and the load can be more efficiently absorbed.

### Second Embodiment

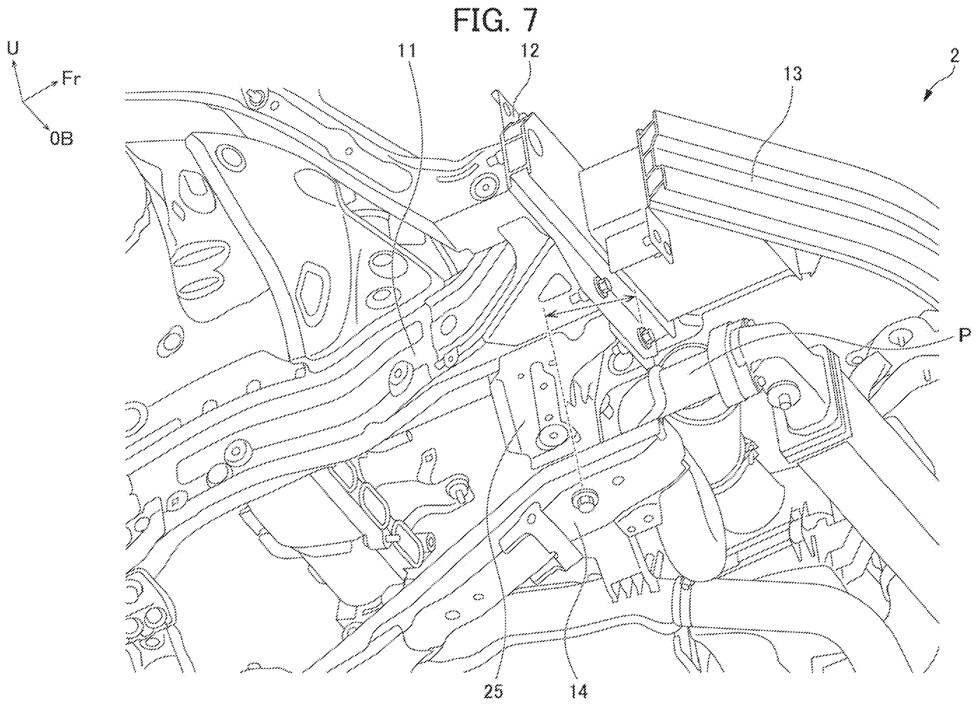

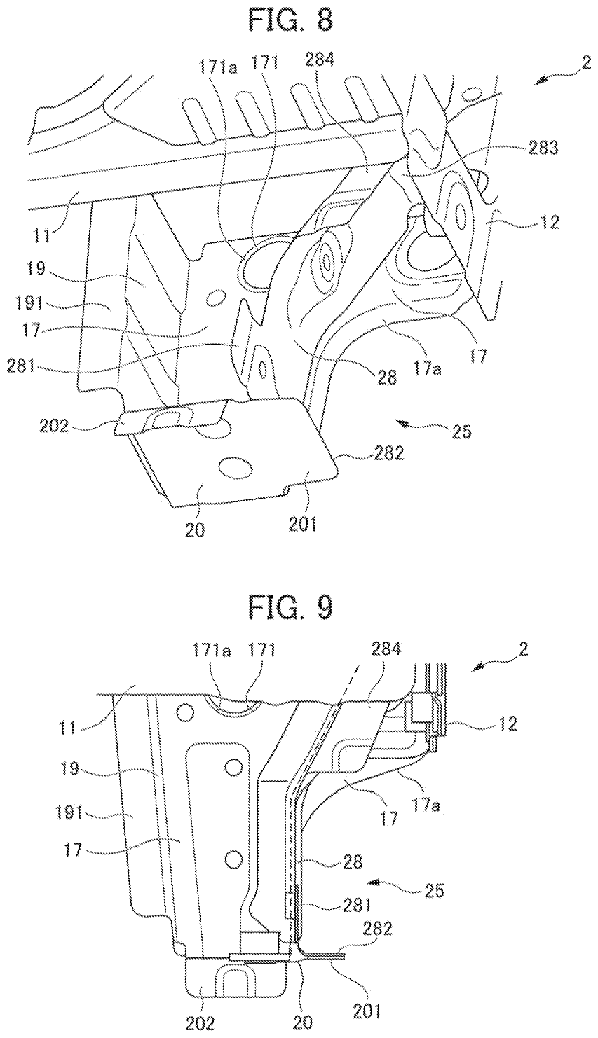

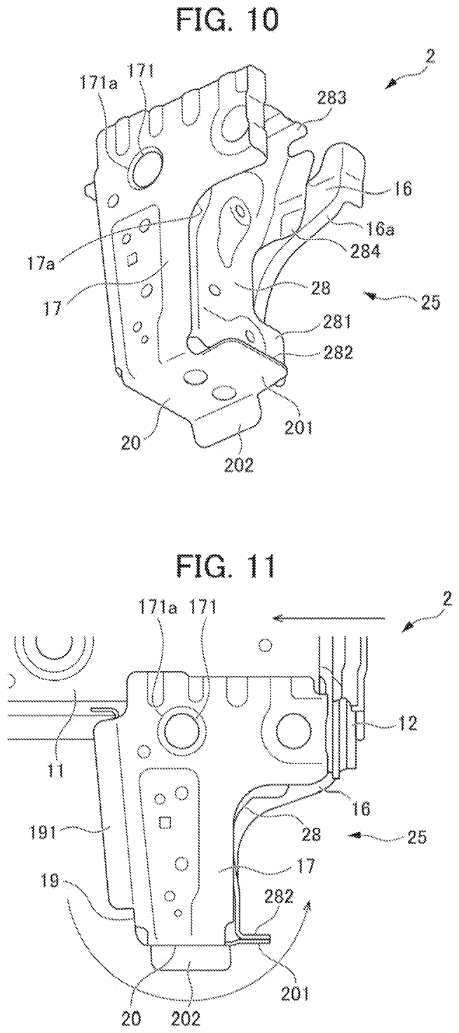

Next, description will be made as to a configuration of a vehicle body front part structure 2 according to a second embodiment of the present invention with reference to FIGS. 7 to 10. FIG. 7 is a perspective view showing a right side part in the vehicle body front part structure 2. FIG. 8 is a perspective view showing a periphery of a right side subframe support 25. FIG. 9 is a side view showing the periphery of the right side subframe support 25. FIG. 10 is a perspective view showing a left side subframe support 25.

The vehicle body front part structure 2 shown in FIGS. 7 to 10 is different from the vehicle body front part structure 1 according to the first embodiment in that the structure includes the subframe support 25 in place of the subframe support 15 according to the first embodiment.

Specifically, the subframe support 25 is different from the subframe support 15 according to the first embodiment in that the subframe support 25 includes a front wall 28 in place of the front wall 18 of the subframe support 15 according to the first embodiment.

The front wall 28 is provided inclining such that an upper part is located more forward than a lower part, in front in the subframe support 15 according to the first embodiment. The upper part of the front wall 28 is fixed directly to a lower part in a front side frame 11 by welding. In the front wall 28, as shown with a dashed line in FIG. 9, inclination angles are different from each other in an upper part and a lower part in the front wall 28. Specifically, a forward inclination angle of the upper part in the front wall 28 is set to be larger than a forward inclination angle of the lower part in the front wall 28. The inclination angle of the lower part in the front wall 28 is about the same as an inclination angle of a front side in a pair of left and right side walls 16 and 17 that inclines forward from bottom toward top.

Additionally, the front wall 28 includes a plurality of welding flanges 281, 282, 283, and 284. The welding flange 281 is a part extending from a side end of the lower part in the front wall 28 on an outer side in a vehicle width direction to the outer side in the vehicle width direction and fixed to a welding flange 161 of the side wall 16 on the outer side in the vehicle width direction by welding. The welding flange 282 is a part bending and extending forward at a lower end in the front wall 28 and fixed to a welding flange 201 of a bottom surface 20 by welding. The welding flange 283 is a part bending and extending forward at an upper end in the front wall 28 and fixed to the lower part in the front side frame 11 by welding. The welding flange 284 is a part bending and extending forward at a side end of the upper part in the front wall 28 on the outer side in the vehicle width direction and fixed to an inner surface of the side wall 16 on the outer side in the vehicle width direction by welding.

Next, description will be made as to load applied to the subframe support 25 of the vehicle body front part structure 2 according to the present embodiment at time of front collision of a vehicle body or the like with reference to FIG. 11. FIG. 11 is a side view showing the left side subframe support 25, and shows the load applied to the subframe support 25 at the time of front collision of the vehicle body.

As shown in FIG. 11, in a case where load (see an arrow in FIG. 11) is applied to the front side frame 11 due to the front collision of the vehicle body or the like and any load is not applied to a subframe 14, load (see an arrow in FIG. 11) is applied such that a lower part in the subframe support 25 rotates relatively upward and forward.

At this time, the vehicle body front part structure 2 according to the present embodiment includes the front wall 28 inclining such that the upper part is located more forward than the lower part, and hence the subframe support 25 can be further inhibited from rotating upward and forward.

Consequently, damage on the subframe support 25 can be suppressed, and the load can be more efficiently absorbed.

Also, according to the vehicle body front part structure 2 of the present embodiment, the inclination angle of the lower part in the front wall 28 is about the same as the inclination angle of the front side in the pair of left and right side walls 16 and 17, so that the front wall 28 and the pair of left and right side walls 16 and 17 can be easily connected.

Note that the present invention is not limited to the above embodiments, and modification, improvement or the like is included in the present invention as long as the object of the present invention can be achieved.

For example, in the above embodiments, an example is described where the pair of left and right side walls 16 and 17, the front wall 18 or 28 and the like form the subframe support 15 or 25, but the present invention is not limited to this example, and a hollow pillar body separate from the pair of left and right side walls 16 and 17, the front wall 18 or 28 and the like may form a subframe support and the pair of left and right side walls 16 and 17, the front wall 18 or 28 and the like may belong to the subframe support. In this case, the pair of left and right side walls 16 and 17, the front wall 18 or 28 and the like may be arranged around the hollow pillar body.

### EXPLANATION OF REFERENCE NUMERALS

1 and 2 vehicle body front part structure
11 front side frame
12 bumper beam bracket
13 bumper beam
14 subframe
15 and 25 subframe support
16 and 17 side wall
16a and 17a flange portion
161, 162, 163, 181, 182, 183, 191, 192, 201, 202, 281, 282,
283, and 284 welding flange
171 hole
171a peripheral edge flange
18 and 28 front wall
19 rear wall
20 bottom surface
P pipe

What is claimed is:

1. A vehicle body front part structure comprising:
a front side frame;
a bumper beam bracket provided at a front end in the front side frame;
a subframe provided below the front side frame; and
a subframe support provided in a standing manner below a position behind the front end in the front side frame,
the subframe support being connected to the subframe,
wherein the subframe support includes a pair of left and right side walls on opposite sides in a vehicle width direction in the subframe support, and
each of the pair of left and right side walls extends forward and is connected to a lower end in the bumper beam bracket.

2. The vehicle body front part structure according to claim 1, wherein the pair of left and right side walls include flange portions each bending in the vehicle width direction.

3. The vehicle body front part structure according to claim 1, wherein each of the pair of left and right side walls has a shape gradually expanding downward from front toward rear.

4. The vehicle body front part structure according to claim 1, wherein the subframe support includes a front wall in front in the subframe support, and
in the front wall, an upper part in the front wall is connected directly to a lower part in the front side frame.

5. The vehicle body front part structure according to claim 1, wherein the subframe support includes a front wall in front in the subframe support, and
the pair of left and right side walls and the front wall include a plurality of welding flanges each extending in a front-rear direction, an up-down direction or a left-right direction, and are welded to one another with the plurality of welding flanges.

6. The vehicle body front part structure according to claim 5, wherein among the plurality of welding flanges, the welding flange extending in the left-right direction extends outward in the vehicle width direction.

7. The vehicle body front part structure according to claim 1, wherein the subframe support includes a front wall in front in the subframe support,
the front wall is provided inclining such that an upper part is located more forward than a lower part, and
the upper part in the front wall is connected to a lower part in the front side frame.

8. The vehicle body front part structure according to claim 7, wherein in the front wall, inclination angles are different from each other in the upper part and the lower part in the front wall, and
the inclination angle of the lower part in the front wall is about the same as an inclination angle made by a front side in the pair of left and right side walls that inclines forward from bottom toward top.

9. The vehicle body front part structure according to claim 7, wherein at least one of the pair of left and right side walls includes a hole in an upper rear portion in the side wall, and
the hole includes a peripheral edge flange extending and bending in the vehicle width direction, in an entire peripheral edge of the hole.

10. The vehicle body front part structure according to claim 9, wherein the peripheral edge flange extends in a curve in the vehicle width direction.
